(19) United States
(12) Patent Application Publication
(10) Pub. No.: US 2022/0264801 A1
(43) Pub. Date: Aug. 25, 2022

(54) METHOD OF CONTROLLING A ROBOTIC HARVESTING DEVICE

(71) Applicant: Noronn AS, Ås (NO)

(72) Inventors: Ya Xiong, Ås (NO); Yuanyue Ge, Ås (NO); Pål Johan From, Ås (NO)

(21) Appl. No.: 17/631,785

(22) PCT Filed: Jul. 27, 2020
(86) PCT No.: PCT/EP2020/071164

§ 371 Date: Jan. 31, 2022

(30) Foreign Application Priority Data
Jul. 31, 2019 (GB) 1910918.0

(51) Int. Cl. A01D 46/30; G06T 7/70

(52) U.S. Cl. CPC A01D 46/30; G06T 7/70; G06T 2207/20021; G06T 2207/30188; G06T 2207/30261

(57) ABSTRACT

A method of controlling a robotic harvesting device to pick a target piece of fruit from a plant includes determining a position of the target piece of fruit, determining a position of one or more obstacles relative to the target piece of fruit , and plotting a path for the robotic harvesting device to be moved along from a starting position to a picking position. The path is plotted such that the movement of the robotic harvesting device along the path serves to move at least some of the obstacles relative to the target piece of fruit so that the obstacles do not impede the picking of the target piece of fruit .

This invention relates to the field of agricultural robots, and specifically to a method of controlling a robotic harvesting device, e.g. to selectively pick a target fruit in a cluster of fruits.

Fruit production that requires selective harvesting is heavily reliant on human labour. This is applicable to crops such as strawberries, sweet peppers, tomatoes, cucumbers, etc. Labour represents the largest cost and also a large operational uncertainty for fruit growers. Therefore, several attempts have been made to develop a robotic solution for the selective harvesting of fruits. One of the major challenges is that the harvesting robots must be able to operate equally efficiently within diverse, unconstrained environments and crop variations with a variety of features.

An important concern is that the fruits in question are often easily damaged or bruised. Therefore, gentle handling during the picking process is required in order to ensure that the harvested produce is of a high quality that is acceptable to the consumer. Additionally, as most fruits tend to ripen at varying rates, resulting in large variations in colour and size, fruit harvesting procedures must be highly selective and often require a number of passes to be made, which can be time consuming.

Furthermore, some fruits, such as strawberries and tomatoes, tend to grow in clusters. This makes it difficult to identify and pick individual ripe fruit without damaging or accidentally picking unripe fruit. Harvesting fruits that grow in clusters or are surrounded by obstacles, such as branches and/or leaves, while leaving the unripe fruit to remain undamaged on the plant, is one of the primary challenges for fruit harvesting systems. The surrounding fruits, leaves, stems and other obstacles are often difficult to separate from the target, both in terms of detection and in manipulation.

The present invention aims to provide an improved method for the selective robotic picking of fruit or vegetables, hereafter collectively referred to as “fruit”.

When viewed from a first aspect, the invention provides a method of controlling a robotic harvesting device to pick a target piece of fruit from a plant, the method comprising:
determining a position of the target piece of fruit to be harvested from the plant;
determining a position of one or more obstacles relative to the target piece of fruit; and
plotting a path for the robotic harvesting device to be moved along from a starting position to a picking position, wherein the path is plotted such that the movement of the robotic harvesting device along the path serves to move at least some of the one or more obstacles relative to the target piece of fruit such that the one or more obstacles do not impede the picking of the target piece of fruit by the robotic harvesting device.

The present invention provides a method of controlling a robotic harvesting device to pick a target piece of fruit from a plant, e.g. to pick a ripe piece of fruit in a cluster of pieces of fruit. The method includes determining the positions of a target (e.g. ripe) piece of fruit on a plant and of obstacle(s) that may hinder the picking of the target successfully by the robotic harvesting device. The determination of these positions then allows the movement that the robotic harvesting device should take towards the target piece of fruit to be plotted. The path is plotted such that the obstacle(s) to the picking process, such as unripe fruit or other ripe fruit, branches and leaves, or other movable obstacles are moved out of the way by the device itself before the device attempts to harvest the target fruit. The position of immovable, i.e. fixed, obstacles such as tables, poles or other infrastructure may be determined, e.g., using deep learning, as discussed below. The plotted path may then be constrained such that the immovable obstacles are avoided.

Plotting a path that deliberately moves obstacles out of the way, rather than simply determining a path of least resistance, means that uncontrolled collisions with obstacles such as unripe or other ripe fruit, which may damage the flesh of the fruit, are avoided. Pushing fruit out of the way, rather than simply avoiding them, as may otherwise be done, also makes it possible to pick fruit that would otherwise be inaccessible to the robotic harvesting device. Furthermore, plotting such a path for the robotic harvesting device means that it is less likely for unwanted fruit or other obstacles to become caught in the picking motion, which both improves the efficiency of the process and reduces damage to the crop. This helps to enable complex clusters of fruit, in which the target fruit may be surrounded by obstacles, to be harvested with a higher efficiency and success rate than conventional devices, while retaining the unripe pieces of fruit on the plant undamaged for them to ripen and be picked at a later date.

Increased picking efficiency may be obtained by categorising the obstacles as fixed or movable obstacles, where the fixed obstacles (such as tables, poles and other infrastructure) may be avoided when plotting the path, while movable obstacles (such as leaves and other fruit) may be actively moved by the robotic harvesting device to reach the target fruit.

The plant, and the target piece of fruit whose position is determined, may be any suitable and desired type of fruit plant. Preferably the plant comprises the target piece of fruit and, e.g., the one or more obstacles. Preferably the fruit is one that is attached to (e.g. hangs from) a fruit plant by a stem, e.g. apples, pears, oranges, etc. Owing to the ability of the method of controlling the robotic harvesting device, at least in preferred embodiments, to handle fruit carefully when harvesting, the method and device are particularly suited (and in embodiments is arranged) to picking soft fruit, e.g. strawberries, raspberries, tomatoes, etc. In a preferred embodiment the method and device are arranged to be controlled to pick pieces of fruit that grow in clusters on a plant, e.g. strawberries, raspberries, tomatoes, etc. It will be appreciated that in some embodiments of the invention the method and device are also suited to picking apples, pears, plums or other such crops (including vegetables) that do not grow in clusters but may be surrounded by obstacles such as branches and/or leaves.

The one or more obstacles, whose positions are also determined, may be any obstacle that is located near to the target piece of fruit and may thus impede the path of the device in approaching the target piece of fruit and/or may impede the device when attempting to pick the target piece of fruit. Such obstacle(s) may, for example, include unripe or other ripe fruit, branches and leaves. When the target piece of fruit is on a plant on which fruit grows in clusters, the obstacle(s) will generally include other pieces of fruit in the cluster in which the target piece of fruit is located. Thus the obstacle(s) may be located near to (e.g. surrounding) the target piece of fruit.

The position of the target fruit and/or the positions of the one or more obstacles may be determined in any suitable and desired way. For example, the position of the target fruit and/or the positions of the one or more obstacles may be determined using one or more position sensors. The one or more position sensors may be any suitable and desired sensors for determining the position of the target fruit and/or the positions of the one or more obstacles, such as an infrared position sensor or an ultrasonic position sensor. However, in preferred embodiments, the position of the target piece of fruit and/or the positions of the one or more obstacles is determined using a visible light sensor, e.g. a camera.

Thus preferably the method comprises capturing image data of the target piece of fruit and/or the positions of the one or more obstacles (e.g. using a visible light sensor), and determining the position of the target piece of fruit and/or the positions of the one or more obstacles using the captured image data. Preferably the method comprises identifying the target piece of fruit and/or the one or more obstacles in the captured image data, e.g. using image recognition. The target piece of fruit and/or the one or more obstacles may be identified in the captured image data using the colour or other characteristics of the target piece of fruit and/or the one or more obstacles in the captured image data (for example, ripe strawberries are red and unripe strawberries are green). In some embodiments, the target fruit and the one or more obstacles may be identified according to one or more (e.g. all) of their size, weight, visual contrast and location within a cluster (or any other suitable factor). In one embodiment, any combination of the above variables could be used together as part of a multivariate analysis or deep learning approach.

The image data of the target piece of fruit and/or the one or more obstacles may be used to generate an image or representation of the target fruit and its surroundings. Preferably the method comprises labeling the target piece of fruit and/or the one or more obstacles as the target piece of fruit and/or the one or more obstacles (however, as outlined below, this may simply be done by centring the (e.g. region of interest determined from the) image or representation on the target piece of fruit). In some embodiments, the method comprises determining whether an identified obstacle is movable or immovable. Immovable, i.e. fixed obstacles, such as tables, poles or other infrastructure in the vicinity of the target piece of fruit, may then be avoided when determining the path, while movable obstacles may be actively moved so that the robotic harvesting device can reach the target piece of fruit.

In preferred embodiments, the step(s) of determining the position(s) of the target to be harvested and/or the obstacles may involve using an image or representation of the target fruit and its surroundings. The target piece of fruit and the one or more obstacles may lie in substantially the same plane, e.g. on a vine or along a wall. Therefore, in some embodiments, a 2D image or representation of the target fruit and its surroundings, e.g. an area around the target fruit, may be used.

Preferably, however, a 3D image or representation of the target fruit and its surroundings, e.g. a volume around the target fruit, is used. The 3D image or representation may be produced in any suitable and desired way. In a preferred embodiment the 3D image or representation is produced by combining the captured image data and depth data. Preferably the depth data is acquired using a depth sensor.

Thus preferably the method comprises capturing data representative of the distance to the target piece of fruit and the one or more obstacles (e.g. from the depth sensor), and preferably the method comprises producing a 3D image or representation of the target piece of fruit and the one or more obstacles using the captured image data and the data representative of the distance to the target piece of fruit and the one or more obstacles (i.e. the depth data). Producing a 3D image or representation of the target piece of fruit and the one or more obstacles helps the path to the target piece of fruit to be determined.

The 3D image or representation may be processed to determine the position of the target fruit and/or the positions of the one or more obstacles, e.g. within a 3D coordinate system. The use of a 3D image or representation, rather than a 2D image, helps to allow a wider range of possible paths to be considered.

Consequently, a path that effectively reduces undesired collisions with obstacles may be selected. However, as discussed above, it may be more appropriate in some circumstances to use a 2D image to simplify the process. Thus in such circumstances, references to 3D images and sub-volumes hereafter may be interpreted as referring to 2D images and sub-areas respectively. Thus it will be appreciated by those skilled in the art that the preferred and optional features described herein relating to 3D images and sub-volumes apply equally to 2D images and sub-areas respectively, as appropriate.

In a preferred set of embodiments the 3D image or representation is processed to determine a region of interest. Thus preferably the method comprises determining a region of interest for the target piece of fruit and the one or more obstacles, e.g. using the 3D image or representation. The region of interest may comprise a volume of the 3D image or representation that contains the target fruit and the one or more obstacles. The dimensions of the region of interest may be predetermined by the user. However, in preferred embodiments, the dimensions of the region of interest are determined by the location of the target and the one or more obstacles. Preferably the boundaries of the region of interest are determined such that the region of interest encompasses the target piece of fruit and (e.g. all of) the one or more obstacles. Preferably the region of interest is centred on the (e.g. centre of the) target piece of fruit.

The (e.g. region of interest determined from the) 3D image or representation may be processed such that it is divided into a plurality of sub-volumes corresponding to a plurality of locations around the target fruit. Thus preferably the method comprises dividing the (e.g. region of interest determined from the) 3D image or representation into a plurality of sub-volumes.

The sub-volumes may be defined by dividing the (e.g. region of interest determined from the) 3D image or representation into a plurality of columns. The sub-volumes may be defined by dividing the (e.g. region of interest determined from the) 3D image or representation into a plurality of rows. Preferably, when the (e.g. region of interest determined from the) 3D image or representation is divided into a plurality of rows, the plurality of rows serve to define one or more (e.g. all of): a sub-volume (e.g. layer) of the (e.g. region of interest determined from the) 3D image or representation that is located above the target, a sub-volume (e.g. layer) of the (e.g. region of interest determined from the) 3D image or representation that is located below the target and a sub-volume (e.g. layer) of the (e.g. region of interest determined from the) 3D image or representation that is located around the target (e.g. such that the target lies (e.g. wholly) within this sub-volume).

In a set of preferred embodiments, the sub-volumes are defined by dividing the (e.g. region of interest determined from the) 3D image or representation into a plurality of columns and a plurality of rows, e.g. such that the plurality of sub-volumes comprise a plurality of cells.

The number of sub-volumes into which the (e.g. region of interest determined from the) 3D image or representation is divided may depend upon the number of obstacles located within the (e.g. region of interest determined from the) 3D image or representation. Preferably, however, the number of sub-volumes is a particular (e.g. predetermined, e.g. constant) number, e.g. 27. In embodiments where the (e.g. region of interest determined from the) 3D image or representation is divided into a plurality of rows, preferably the plurality of rows comprises two or more, e.g. three or four, rows. In embodiments where the 3D image or representation is divided into a plurality of columns, preferably the plurality of columns comprises two or more, e.g. five or more, e.g. nine, columns.

The plurality of sub-volumes may have any suitable shape. For example, the plurality of sub-volumes may be wedge shaped. However, in a set of preferred embodiments, the plurality of sub-volumes are cuboids. Thus, preferably the rows and/or the columns comprise planar, and parallel or perpendicular, boundaries between them.

The plurality of sub-volumes may have any suitable dimensions. For example, the dimensions of each sub-volume may be set according to the size or number of obstacles that are located within it. However, in a set of preferred embodiments, one or more (e.g. two or more, e.g. all) of the dimensions of the sub-volumes are equal to one or more (e.g. two or more, e.g. all) of the dimensions of a cuboid that encompasses (e.g. the extremities of) the target piece of fruit.

The dimensions of at least one (e.g. all) of the plurality of sub-volumes may be determined according to the size of the target fruit. Preferably the (e.g. region of interest determined from the) 3D image or representation is divided into a plurality of sub-volumes such that the (e.g. region of interest determined from the) 3D image or representation comprises a central sub-volume. Preferably the target is located within the central sub-volume. In such embodiments, preferably the dimensions of the central sub-volume are determined according to the size of the target fruit, e.g. such that the central sub-volume encompasses (e.g. the extremities of) the target piece of fruit.

The step of determining the position of the one or more obstacles relative to the target piece of fruit may comprise calculating the (e.g. precise) position of the one or more obstacles relative to the target piece of fruit. This may comprise calculating the distance between (e.g. each of) the one or more obstacles and the target, e.g. by calculating the coordinates of (e.g. each of) the one or more obstacles and the coordinates of the target, using the 3D image or representation. However, in other embodiments, the determined position of the one or more obstacles relative to the target piece of fruit may not be a precise position. For example, a general position of the one or more obstacles may be determined by identifying which of a number of areas around the target piece of fruit contain obstacles, as will be described below.

Thus, it will be appreciated that the claimed method may comprise determining the precise location of the target piece of fruit and a precise position of the one or more obstacles, or the precise location of the target piece of fruit and a general position of the one or more obstacles.

In embodiments when the (e.g. region of interest determined from the) 3D image or representation is divided into sub-volumes, determining a position of one or more obstacles relative to the target may comprise determining which of the plurality of sub-volumes contains an obstacle (with each of the plurality of sub-volumes having a position (e.g. corresponding to the centre of the sub-volume) associated with it). (E.g. each of) the plurality of sub-volumes may be provided with a characteristic that is indicative of whether an obstacle is located within them.

This characteristic may be a continuous value that indicates an extent to which a sub-volume is occupied, e.g. a ratio of occupied volume to unoccupied volume of the obstacle in the sub-volume. Alternatively, the characteristic may be a discrete value. In a set of preferred embodiments, the characteristic comprises a binary value. The use of a binary value to indicate whether or not an obstacle is located within a certain region around the target fruit helps to provide a simple flag and means that the positions of the obstacles can be simply and efficiently determined.

In a preferred set of embodiments, the method comprises determining the position of one or more regions (e.g. corresponding to one or more of the sub-volumes) of the (e.g. region of interest determined from the) 3D image or representation around the target that are (e.g. completely) free from obstacles. As will be described below, the free region(s) (e.g. along with the positions of the one or more obstacles) may be used to help plot the path for the robotic harvesting device to take into account the region(s) surrounding the target piece of fruit that are free and suitable for the robotic harvesting device to approach the target piece of fruit. This may help to reduce the number of obstacles that the robotic harvesting device has to move out of the way while moving towards the target piece of fruit.

The path for the robotic harvesting device to be moved along may be plotted (i.e. determined) in any suitable and desired way. Preferably the path is plotted according to (i.e. using) the (determined) positions of the one or more obstacles and the target fruit. In one embodiment the starting position is a position remote from the target piece of fruit and the one or more obstacles, e.g. remote from the plant on which the target piece of fruit is growing. Preferably the starting position is the position from which the positions of the target piece of fruit and the one or more obstacles are determined (e.g. from which the image data and the depth data are captured). In one embodiment the picking position is a position proximate to the target piece of fruit. Moving the robotic harvesting device into the picking position allows the target piece of fruit to be picked from the plant by the robotic harvesting device.

The picking position may be any suitable and desired position relative (preferably proximate) to the (e.g. determined position of the) target piece of fruit, e.g. depending on the nature of the robotic harvesting device. For example, if the robotic harvesting device is configured to pick the target piece of fruit from the side, the picking position may be (e.g. immediately) to the side of the (e.g. determined position of the) target piece of fruit. In a preferred embodiment the picking position is (e.g. immediately) below the (e.g. determined position of the) target piece of fruit, e.g. when the robotic harvesting device is configured to pick a piece of fruit from below.

The step of plotting a path for the robotic harvesting device to be moved along preferably comprises determining a set of one or more path vectors. Preferably the one or more path vectors are grouped into one or more stages of the path along which the robotic harvesting device is to be moved.

Where the (e.g. region of interest determined from the) 3D image or representation is divided into rows, preferably each stage determined for the path corresponds to a row. Preferably (e.g. when the robotic harvesting device is configured to pick a piece of fruit from below) the path is determined such that the path traverses the bottom row before traversing the upper (e.g. middle and top) rows. Thus, preferably the start of each subsequent (e.g. higher) stage starts at the end of the previous (e.g. lower) stage such that the robotic harvesting device moves upwards towards the target.

Preferably the one or more path vectors are determined using the determined positions of the one or more obstacles, e.g. relative to the target piece of fruit.

When a plurality of path vectors have been determined, preferably the path is plotted by plotting each of the plurality of determined path vectors sequentially, e.g. so that the end point of a first vector is the starting point of a second vector and so forth. Thus, by following the sequence of path vectors, the robotic harvesting device moves along each path vector in turn.

In embodiments where the (e.g. region of interest determined from the) 3D image or representation is divided into a plurality of sub-volumes, each of the plurality of sub-volumes may be assigned one of a plurality of sub-vectors. The plurality of sub-vectors may be used in order to calculate each of the plurality of path vectors.

The directions of each of the plurality of sub-vectors may be determined according to the precise location of an obstacle that is located within the corresponding sub-volume. For example, the sub-vector may be directed from the centre of the obstacle to the centre of the target fruit. However, in a set of preferred embodiments the corresponding sub-vector is directed from the centre of the sub-volume to the centre of the target fruit (e.g. located at the centre of the region of interest).

The directions of one or more of the plurality of path vectors may be calculated according to the precise position of the one or more obstacles relative to the target piece of fruit. However, preferably the directions of each of the plurality of path vectors is calculated from a subset of sub-vectors that corresponds to a subset of sub-volumes. Preferably the subset of sub-volumes is determined using the determined positions of the one or more obstacles (e.g. relative to the target piece of fruit) within the (e.g. region of interest determined from the) 3D image or representation. For example, the plurality of sub-volumes may be categorised into sets of occupied sub-volumes, in which obstacles are located, and unoccupied sub-volumes, which are free of obstacles.

Thus, in embodiments when (e.g. each of) the plurality of sub-volumes is provided with a characteristic that is indicative of whether an obstacle is located within them, preferably the subset of sub-volumes is determined using this characteristic. The method preferably comprises grouping the plurality of sub-volumes into subsets, wherein each subset comprises a plurality of sub-volumes all having the same characteristic (e.g. occupied or non-occupied). In a preferred embodiment, a (e.g.

each) subset of sub-volumes comprises the largest group of adjacent sub-volumes that all have the same characteristic.

Thus preferably the method comprises grouping the plurality of sub-volumes into subsets, wherein each subset comprises a plurality of adjacent sub-volumes all having the same characteristic (e.g. occupied or non-occupied) and selecting the subset of adjacent sub-volumes having the largest group of adjacent sub-volumes that all have the same characteristic. The subset of sub-volumes may comprise the largest group of adjacent sub-volumes that contain obstacles or may comprise the largest group of adjacent sub-volumes that do not contain obstacles.

When the (e.g. region of interest determined from the) 3D image or representation is divided into a plurality of rows and a plurality of columns, the subset of sub-volumes for each path vector may comprise sub-volumes taken from different rows. However, preferably, the subset of sub-volumes for each path vector comprises sub-volumes from the same row. Thus preferably a subset of sub-volumes (and an associated path vector) is determined separately for each row of the (e.g. region of interest determined from the) 3D image or representation. Thus, preferably each of the path vectors is associated with a different region around the target piece of fruit.

The path determined for the robotic harvesting device may be linear or non-linear. Preferably the path comprises a plurality of linear movements, e.g. corresponding to the plurality of path vectors. However, in some embodiments, the path may comprise a plurality of linear and non-linear movements. Preferably at least a portion of the path comprises an oscillating (e.g. zig-zag) movement towards the target fruit, e.g. superimposed on one or more of the path vectors. Preferably the zig-zag movement is superimposed on the path vector determined for the row in which the target piece of fruit is located (e.g. the central row of the (e.g. region of interest determined from the) 3D image or representation). In some embodiments, the zig-zag movement may be superimposed on the path vector determined for the rows above or below the row in which the target piece of fruit is located (e.g. the bottom or top rows of the (e.g. region of interest determined from the) 3D image or representation).

Determining, and, e.g., then moving the robotic harvesting device along, an oscillating (e.g. zig-zag) path towards the target piece of fruit helps to move any obstacles out of the way of the target piece of fruit. Preferably the frequency and/or the amplitude of the oscillating (e.g. zig-zag) movement is determined using one or more (e.g. all) of: the determined positions of the one or more obstacles, the peduncle length or the damping ratio of the fruit. Such data may be collected and analysed in order to determine the most effective zig-zag motion for different scenarios.

In some embodiments, the step of determining the path comprises determining a movement of the robotic harvesting device such that the target, rather than an obstacle, is moved by the robotic harvesting device. This may comprise a dragging operation in which the target fruit is dragged by the robotic harvesting device to a more suitable region for picking. This may be applicable when the embodiments of the present invention are applied to robotic harvesting devices that approach the target from below and an obstacle is located above the target.

The dragging operation allows the target to be moved to be below an area that contains fewer obstacles so that the robotic harvesting device is able to pick the target fruit without picking or damaging unwanted obstacles. Preferably the dragging operation comprises positioning the robotic harvesting device relative to the target piece of fruit such that movement of the robotic harvesting device moves the target piece of fruit, e.g. positioning the robotic harvesting device such that the locating members of the robotic harvesting device are positioned around the target piece of fruit.

In some embodiments (e.g. when the precise position of the one or more obstacles is determined), the starting position of the path (or an initial position of the path, before the robotic harvesting device is moved to approach the target piece of fruit) may lie at the midpoint of the largest angle between two obstacles. This angle defines the clearest “entrance” for the robotic harvesting device so that it can access the target fruit with reduced risk of colliding with obstacles. Thus preferably the method comprises determining the largest opening angle between two obstacles (having no other obstacles therebetween) and positioning the robotic harvesting device at the midpoint of the opening angle.

Preferably, the path is determined such that the robotic harvesting device is moved to come into contact with one or more obstacles. This enables the robotic harvesting device to push the one or more obstacles out of the way. Preferably, the path is determined such that the movement of the robotic harvesting device along the path serves to move the one or more obstacles into the one or more regions around the target that are free of obstacles.

Once the path has been plotted, preferably the method comprises moving the robotic harvesting device (e.g. energising a motor of the robotic harvesting device to move the robotic harvesting device) along the plotted path from the starting position to the picking position. Preferably the method comprises controlling the robotic harvesting device to pick the target piece of fruit.

The invention also extends to an apparatus for picking fruit. Thus, when viewed from a second aspect, the invention provides an apparatus for picking a target piece of fruit from a plant, the apparatus comprising:
a picking device for detaching the target piece of fruit from the plant;
a manoeuvring mechanism for moving the picking device along a path towards the target piece of fruit;
one or more sensors for capturing data representative of the position of the target piece of fruit and the one or more obstacles; and
processing circuitry operable to:
   determine a position of the target piece of fruit to be harvested from the plant using the data captured by the one or more sensors;
   determine a position of one or more obstacles relative to the target piece of fruit using the data captured by the one or more sensors; and
   plot the path for the picking device to be moved along from a starting position to a picking position by the manoeuvring mechanism, wherein the path is plotted such that the movement of the robotic harvesting device along the path serves to move at least some of the one or more obstacles relative to the target piece of fruit such that the one or more obstacles do not impede the picking of the target piece of fruit by the robotic harvesting device.

As will be appreciated by those skilled in the art, this aspect of the present invention can, and preferably does, include any one or more or all of the preferred and optional features of the present invention discussed herein, as appropriate. Thus preferably the apparatus comprises a robotic harvesting device. Preferably the processing circuitry is operable to control the manoeuvring mechanism to move the picking device along the determined path from the starting position to the picking position.

The picking device may comprise any suitable device for picking the target piece of fruit. The picking device may comprise a gripper (e.g. a plurality of locating members), arranged to surround the target fruit. Preferably the (e.g. gripper of the) picking device comprises a cutter (e.g. positioned on or relative to one of the locating members) arranged to cut the target piece of fruit from the plant (e.g. by cutting a stem of the target piece of fruit).

In one set of embodiments the manoeuvring mechanism comprises a robotic arm. Preferably the apparatus comprises one or more motors arranged to drive the manoeuvring mechanism.

In some embodiments the sensor comprises a distance (e.g. depth) sensor. In some embodiments the sensor may comprise an infrared sensor or an ultrasonic sensor. However, in preferred embodiments, the sensor comprises a visible light sensor, e.g. a camera.

The various components of the apparatus may be arranged relative to each other in any suitable and desired way. For example, the processing circuitry and/or the sensor may be located on a fixed part of the apparatus. Preferably the picking device is mounted on the manoeuvring mechanism (e.g. on the end of the robotic arm), such that the picking device may be moved relative to the fixed part of the apparatus.

In some embodiments, the path is determined before the movement of the picking device along the path commences. However, in some embodiments, the positions of the obstacles and the target fruit are continuously updated so that the path may be continuously recalculated as the picking device is moving. This allows the method to be used as part of a closed-loop system in order to improve accuracy.

The methods in accordance with the present invention may be implemented at least partially using software e.g. computer programs. It will thus be seen that when viewed from further embodiments the present invention provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. Thus the invention extends to a computer readable storage medium storing computer software code which when executing on a data processing system performs the methods described herein.

The present invention also extends to a computer software carrier comprising such software arranged to carry out the steps of the methods of the present invention. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the present invention need be carried out by computer software and thus from a further broad embodiment the present invention provides computer software and such software installed on a computer software carrier for carrying out at least one of the steps of the methods set out herein.

The present invention may accordingly suitably be embodied as a computer program product for use with a computer system. Such an implementation may comprise a series of computer readable instructions either fixed on a tangible, non-transitory medium, such as a computer readable storage medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Certain preferred embodiments for the invention will now be described, by way of example only, with reference to the accompanying drawings in which:

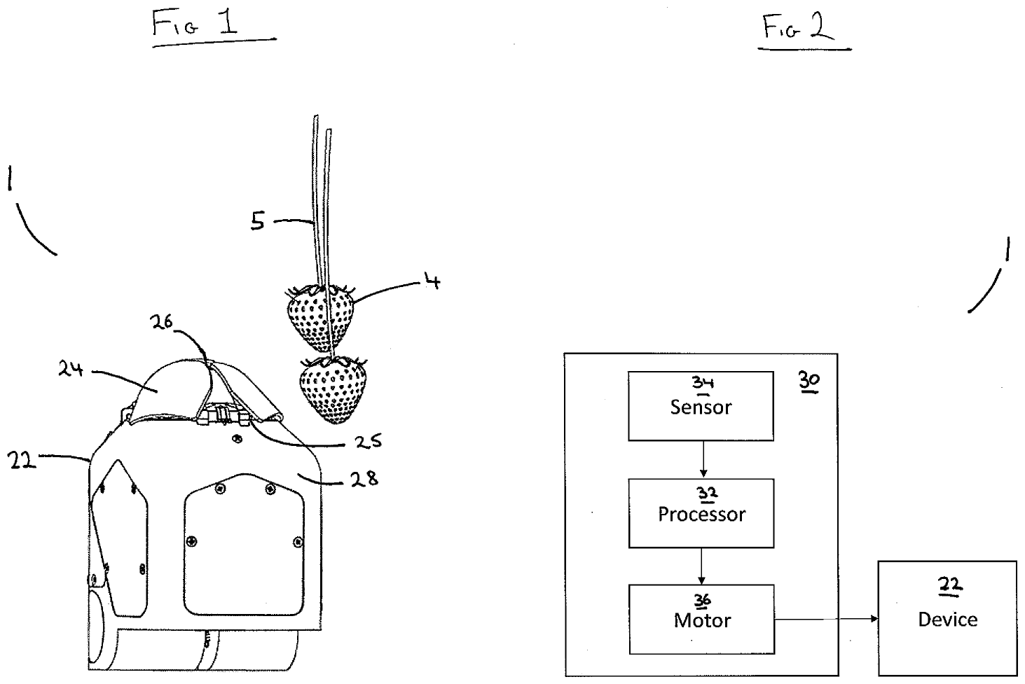

FIG. 1 shows an apparatus for picking fruit in accordance with an embodiment of the present invention;

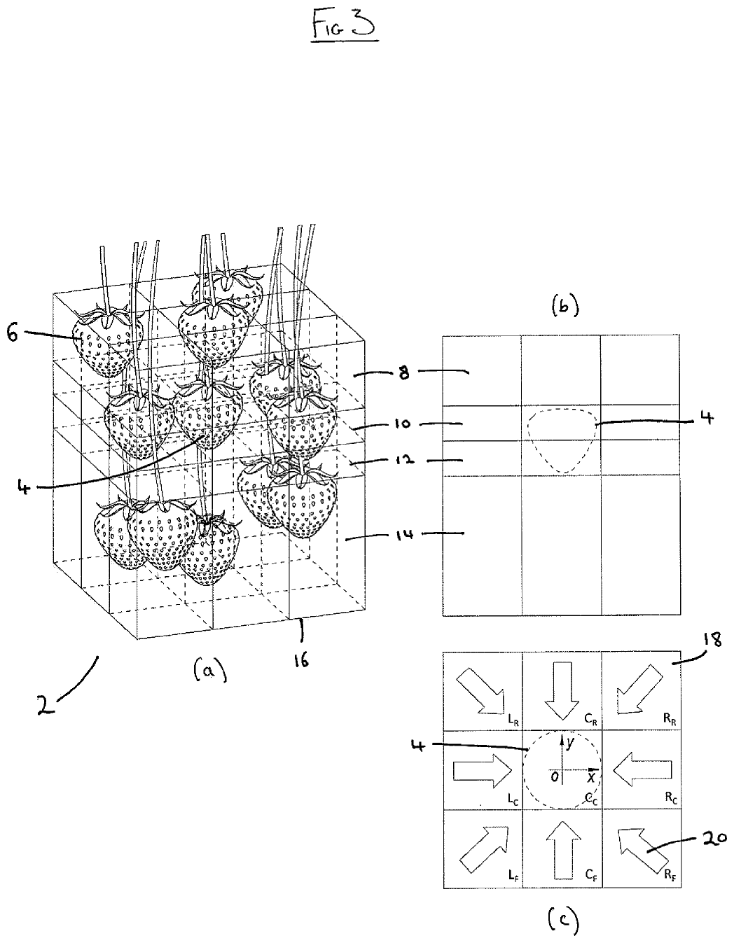

FIG. 2 shows a schematic of the data transfer within the apparatus shown in FIG. 1;

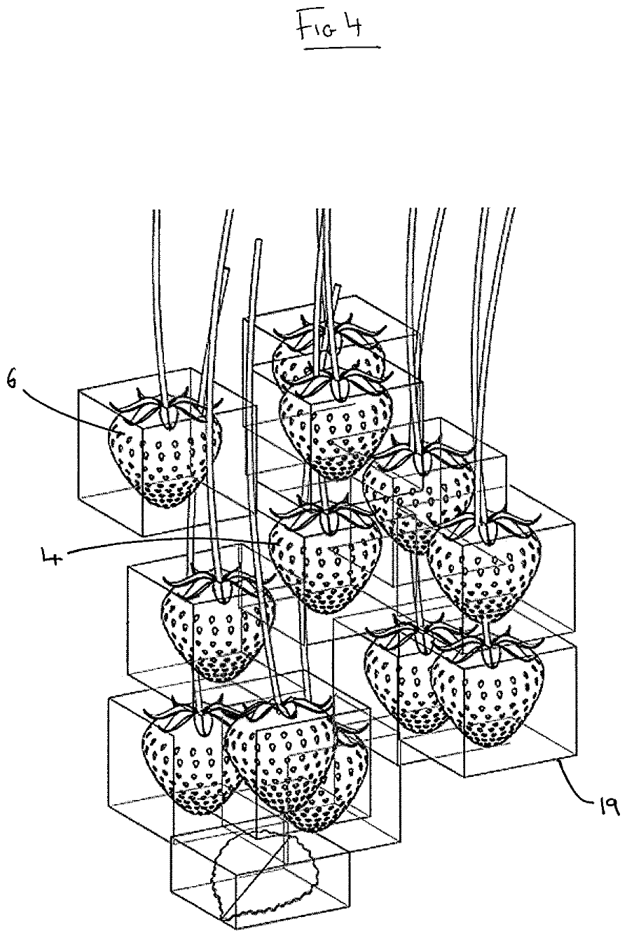

FIGS. 3a, 3b and 3c show segmented views of a cluster of strawberries, including a target strawberry to be picked by the apparatus of FIG. 1 in accordance with an embodiment of the present invention;

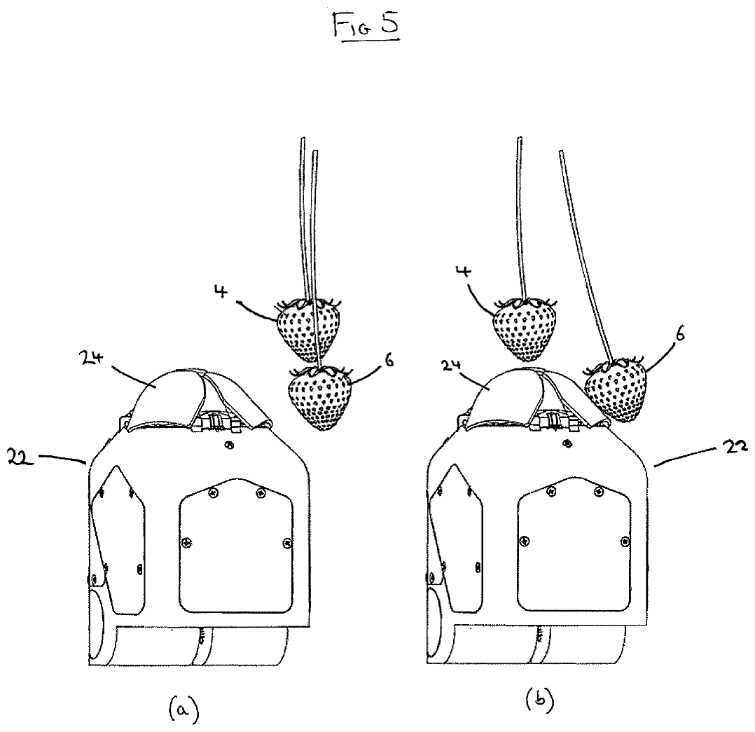

FIG. 4 shows a perspective view of a cluster of strawberries in which the precise position of each object has been determined;

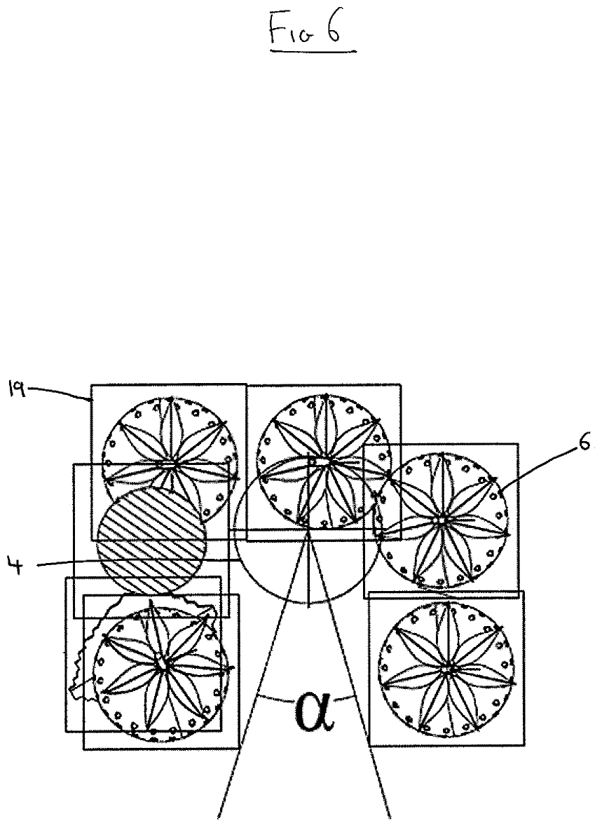

FIGS. 5a and 5b show the apparatus shown in FIG. 1 moving an obstacle in accordance with an embodiment of the present invention;

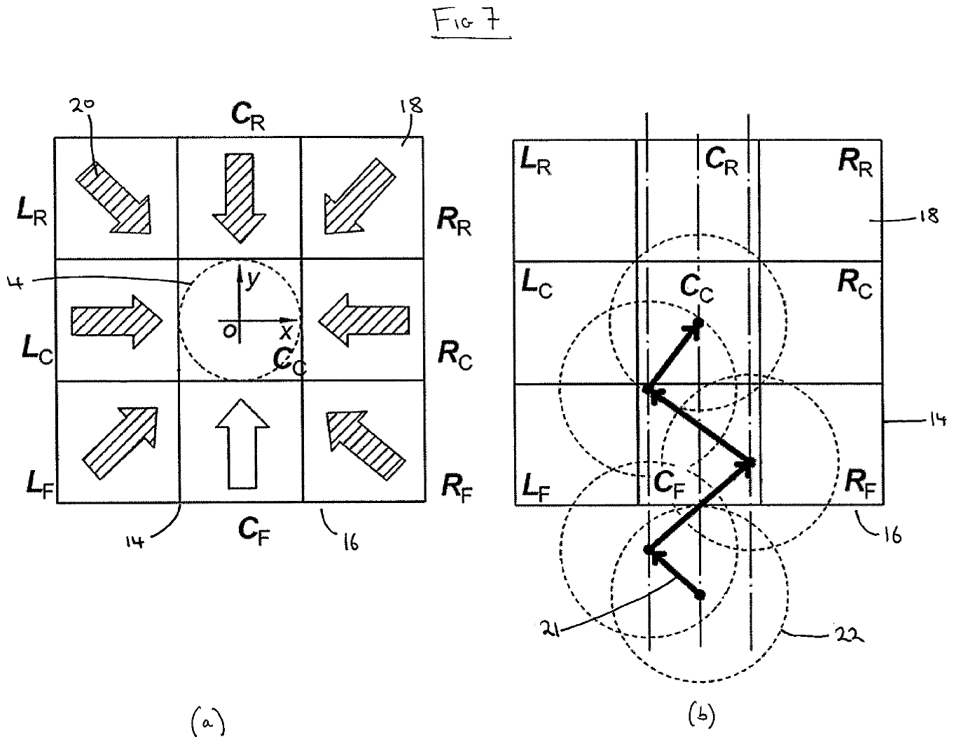

FIG. 6 shows a plan view of the cluster of strawberries shown in FIG. 4;

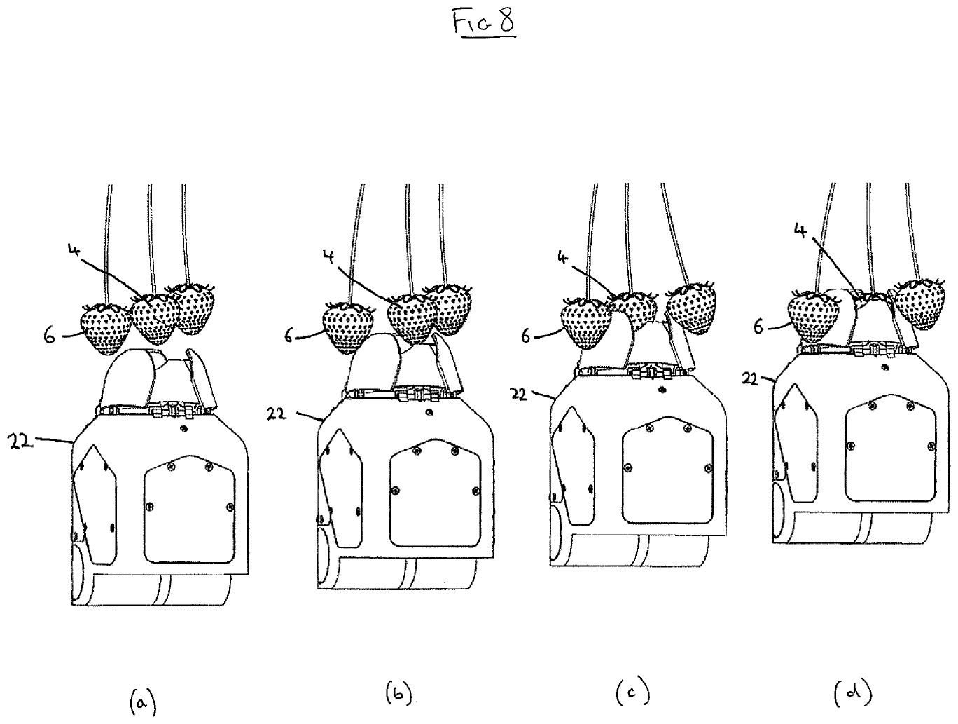

FIGS. 7a and 7b show plan views of the movement of a device according to a horizontal multi-push operation in accordance with an embodiment of the present invention;

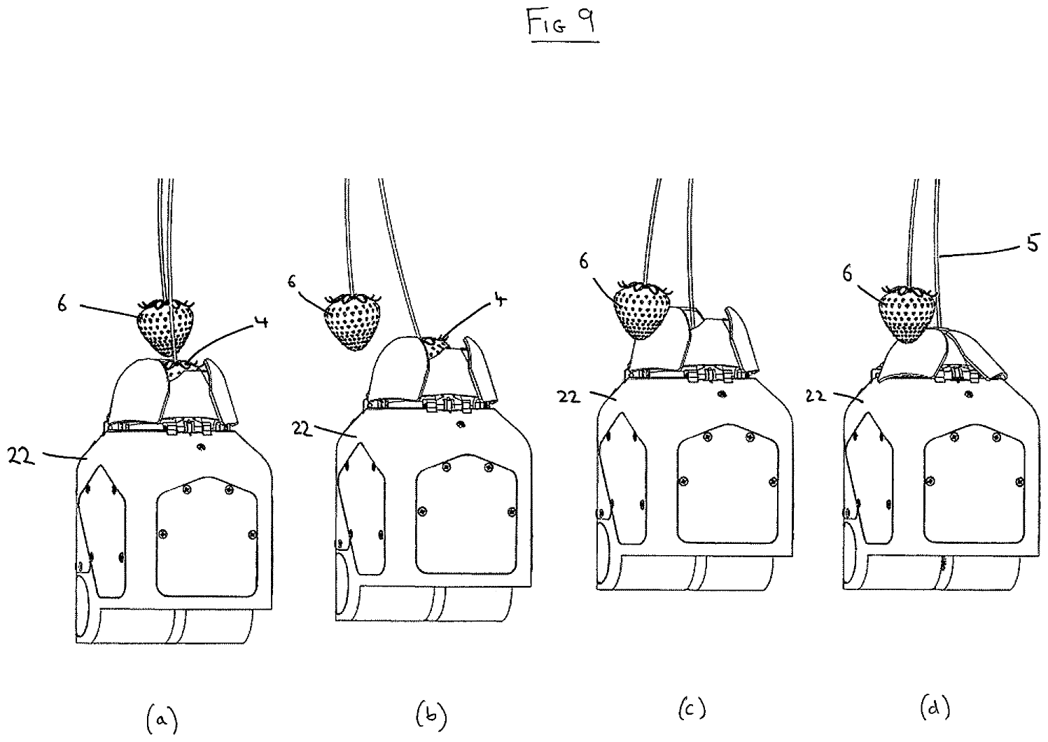

FIGS. 8a, 8b, 8c and 8d show the apparatus shown in FIG. 1 moving two further obstacles in accordance with an embodiment of the present invention;

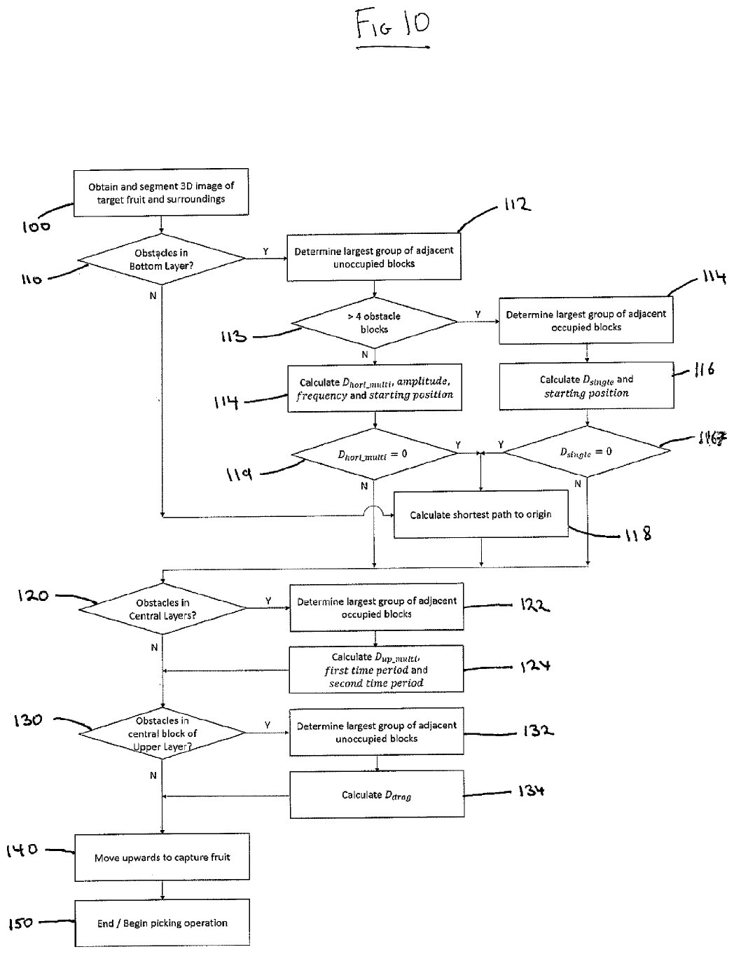

FIGS. 9a, 9b, 9c and 9d show the apparatus shown in FIG. 1 moving a further obstacle in accordance with an embodiment of the present invention; and

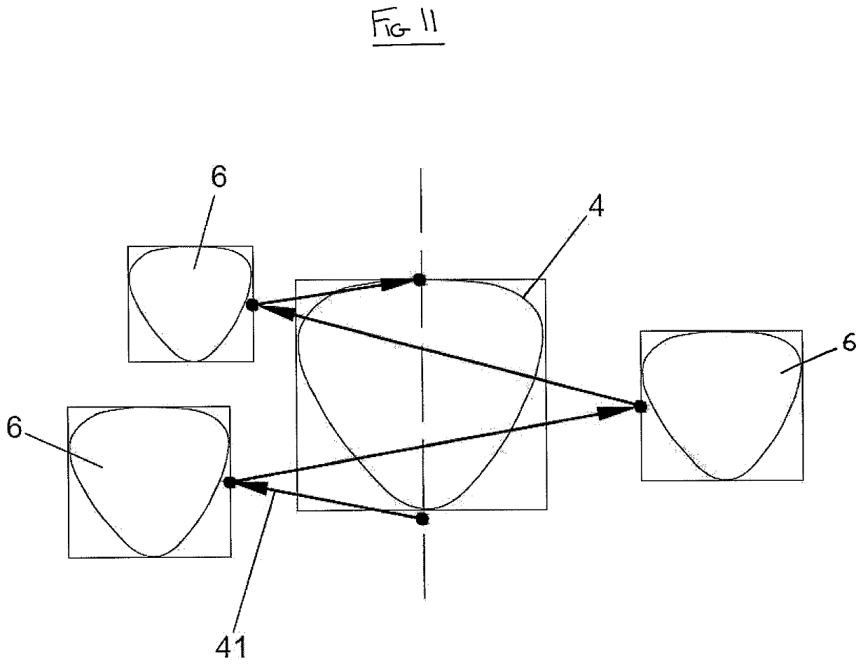

FIG. 10 shows a flowchart illustrating the method steps of an exemplary embodiment of the present invention;

FIG. 11 shows a front view of the movement of a device according to an upwards multi-push operation in accordance with an embodiment of the present invention.

Robotic harvesting devices that are moved towards an individual, target piece of fruit in order to perform picking operations are moved along a determined path. The method by which this path is determined affects the efficiency and accuracy of the harvesting process and may help to reduce the risk of damaging both the target piece of fruit and other pieces of fruit on the plant. The operation of a robotic harvesting device in accordance with the present invention will now be described.

FIG. 1 shows an apparatus 1 for picking a target piece of fruit in accordance with an embodiment of the present invention.

The apparatus 1 comprises a strawberry picking device 22 mounted on a robotic arm 30 (not shown in FIG. 1). The strawberry picking device 22 comprises a container 28 which is provided with an aperture 25 for receiving a target strawberry 4. The device 22 further comprises a number of locating members 24, hingedly mounted around the aperture 25 such that they may be pivoted to open and close the aperture 25.

Prior to picking a target (e.g. ripe) strawberry 4, the locating members 24 are pivoted outwards in order to open the aperture 25. As a result of the movement of the device 22 along a path (determined in accordance with an embodiment of the present invention, as will be explained), the device 22 is moved to receive a target strawberry 4 within the aperture 25. Following initiation of the picking process, the locating members 24 are configured to close around the stem 5 of the target strawberry 4.

A cutting mechanism 26, mounted on an inside surface of one of the locating members 24 is arranged to cut the stem 5 of the target strawberry 4, allowing the target strawberry 4 to be collected in the container 28.

FIG. 2 shows a schematic of the components of, and the data transfer within, the apparatus 1 shown in FIG. 1. The apparatus 1 comprises a robotic arm 30, comprising a processor 32, a motor mechanism 36 (e.g, of one or more motors) and a sensor 34 (comprising a visible light camera and a depth sensor).

In alternative arrangements, the sensor 34 may be mounted on the device 22 or on a separate movable platform connected thereto.

The visible light camera and the depth sensor are configured to capture image data and distance data of a cluster of strawberries. The processor 32 is configured to receive the captured data from the visible light camera and the depth sensor, to identify a target (e.g. ripe) strawberry 4 to pick, and to determine a path for the strawberry picking device 22 to follow, according to an embodiment of the present invention, to enable the strawberry picking device 22 to pick the target strawberry 4. Path instructions, once the path has been determined, are sent from the processor 32 to the motor mechanism 36, which manoeuvres the strawberry picking device 22 accordingly.

The process of determining a path along which the strawberry picking device 22 is to be moved, in order to pick a target strawberry 4, will now be described with reference to FIGS. 1-11. FIGS. 3a, 3b and 3c show segmented views of a cluster of strawberries 6, including a target strawberry 4 to be picked by the apparatus 1 of FIG. 1, in accordance with an embodiment of the present invention.

To determine the path along which the strawberry picking device 22 is to be moved, in order to pick the target strawberry 4, the processor 32 is configured to process the captured data from the visible light camera and the depth sensor to produce a 3D image 2 of the target strawberry 4 and its surroundings. FIG. 3a shows an exemplary 3D image 2 of a target strawberry 4 that is to be picked from within a cluster of other strawberries 6.

Once the target (e.g. ripe) strawberry 4 has been identified, the 3D image 2 is processed by the processor 32 to determine a Region of Interest (ROI) 16, comprising a cuboid volume around the target strawberry 4. The ROI 16 is dimensioned according to user-defined parameters, e.g. such that the ROI 16 encompasses all the strawberries in the cluster 6. The ROI 16 is centred on the target strawberry 4. Objects outside the ROI 16 are ignored.

The processor 32 is configured to divide the 3D image 2 into four horizontal layers: a top layer 8, an upper-central layer 10, a lower-central layer 12 and a bottom layer 14. FIG. 3b shows a front elevation of the 3D image 2. The top layer 8 extends along the z-axis from the highest point of the target strawberry 4 towards the top of the ROI 16. The upper-central layer 10 extends from the vertical midpoint of the target strawberry 4 to the highest point of the target strawberry 4. The lower-central layer 12 extends from the vertical midpoint of the target strawberry 4 to the lowest point of the target strawberry 4. The bottom layer 14 extends from the lowest point of the target strawberry 4 to the bottom of the ROI 16.

In alternative embodiments where the precise positions of both the target piece of fruit 4 and the one or more obstacles 6 are known, the one or more obstacles 6 may be marked with bounding boxes 19, which define the outer edges of each obstacle 6 and the target piece of fruit 4, as shown in FIG. 4.

However, in accordance with the above-described embodiment of the invention where only the general positions (for example, 3D points) of the one or more obstacles are known, FIG. 3c shows a plan view of the ROI 16. Each layer 8, 10, 12, 14 of the ROI 16 is further segmented into nine blocks 18. On each layer, the blocks 18 are arranged in a 3×3 grid that has its centre at the horizontal midpoint of the target strawberry 4 such that the central block C_{C} encompasses the position of the target strawberry 4 in the xy plane.

Each block 18 is assigned a vector 20 representative of the direction from the block 18 to the central block C_{C}. The direction of the vector 20 is determined by the position of the block 18 so that all vectors 20 are directed from the centre of the corresponding block 18 towards the centre of the central block C_{C}.

If an obstacle 6 is detected within a block 18, the block 18 is labeled as being occupied. If no obstacle 6 is detected within a block 18, the block 18 is labeled as being unoccupied.

The picking device 22 is instructed by the processor 32 to operate in four distinct stages. During the first stage, the device 22 moves obstacles 6 within the bottom layer 14 of the ROI 16. During the second stage, the device 22 moves obstacles 6 within the lower-central layer 12 and the upper central layer 10. During the third stage, the device 22 moves the target 4 into a picking position. During the fourth stage, the device 22 moves upwards to pick the target 4.

FIGS. 5a and 5b show a strawberry picking device 22 operating in accordance with the first stage of operation.

In FIG. 5a, the device 22 is in (e.g. has been moved to) a starting position close to a target strawberry 4 and an obstacle strawberry 6, which is located in the bottom layer 14 of the ROI 16. Obstacles 6 in other layers of the ROI 16 have been removed from FIGS. 5a and 5b to improve clarity.

As shown in FIG. 5a, the obstacle 6 is located directly below the target 4. Therefore, if the device 22 were to simply approach the target 4 from below, without moving the obstacle 6 out of its path, the obstacle 6 may be captured by the device 22. This is undesirable, for example, when the obstacle 6 is an unripe strawberry.

In FIG. 5a, the obstacle 6 is identified as being within the central block C_{C} of the bottom layer 14 of the ROI 16. The processor 32 subsequently determines the largest group of unoccupied blocks 18 that are adjacent to each other within the bottom layer 14.

If the number of blocks 18 within the largest group of adjacent unoccupied blocks 18 is equal to or greater than a predetermined threshold (in this exemplary embodiment, four or more blocks 18), the processor 32 determines that a single-push operation of the device 22 is appropriate to move the obstacle(s) out of the way. The direction of the single-push operation for the device 22 is calculated based on the positions of the occupied blocks 18 according to the following equation:

$${D}_{single} = - {\sum }_{i}^{n} {X}_{i} \qquad ( 1 )$$

In Equation 1, Xᵢ is the vector of the i^{th} occupied block 18 within the largest group of adjacent occupied blocks 18 and n is the total number of blocks 18 within the largest group of adjacent occupied blocks 18. Thus it will be appreciated that the direction is chosen such that the movement of the device 22 serves to move the obstacles 6 away from the target fruit 4 prior to picking. If only the central block C_{C} is occupied, as shown in FIGS. 5a and 5b, then D_{single}=0. In this situation, the direction in which the device 22 must move in order to push the obstacle 6 is instead determined by calculating the shortest path from the current location of the device 22 to the centre of the bottom layer 14, i.e. the centre of the central block C_{C}.

In the scenario shown in FIG. 5a, as there is only one obstacle 6 located within the bottom layer 14, the processor 32 determines that a single-push operation is appropriate. FIG. 5a shows the device 22 in a starting position that it has been moved to by the robotic arm 30. The starting position is determined according to the size of the blocks 18 (which is determined from the size of the target fruit 4) and the size of the device 22 such that edge of the device 22 that is nearest the target fruit 4 is coincident with the edge of the ROI 16. In other embodiments, the starting position may be adjusted according to the characteristics of the crop to be harvested.

Alternatively, the starting position may be determined by calculating the largest angle α of a region around the target 4 that is free of obstacles 6. For example, the starting position may lie a predetermined distance from the target 4 at the midpoint of α. FIG. 6 shows an exemplary plan view of the arrangement shown in FIG. 4, in accordance with an embodiment of the invention in which the precise positions of both the target piece of fruit 4 and the one or more obstacles 6 are known. Bounding boxes 19 marking the positions of each of the obstacles 6 have been determined and the largest angle α of a region around the target 4 that is free of obstacles 6 is subsequently calculated.

FIG. 5b shows the location of the device 22 once the single-push operation has been completed. During this operation the locating members 24 of the device 22 are moved to come into contact with and push the obstacle 6. As can be seen, the movement of the device 22 has served to relocate the obstacle 6 such that it will no longer impede the upwards picking motion of the device 22 towards the target strawberry 4.

If the largest group of adjacent unoccupied blocks 18 comprises fewer than the threshold number of blocks 18 (e.g. four blocks 18), the processor 32 determines that a horizontal multi-push operation of the device 22 is appropriate. The overall direction of the horizontal multi-push operation for the device 22 is calculated based on the positions of the unoccupied blocks 18 according to the following equation:

$${D}_{hori\_multi} = ( {\sum }_{j}^{m} {X}_{j} ) \qquad ( 2 )$$

In Equation 2, Xⱼ is the vector of the j^{th} unoccupied block 18 within the largest group of adjacent unoccupied blocks 18 and m is the total number of blocks 18 within the largest group of adjacent unoccupied blocks 18.

During a horizontal multi-push operation, the device 22 moves according to a zig-zag motion in the xy plane, wherein the resultant vector of the zig-zag motion is equal to D_{hori_multi} and the amplitude and frequency of the zig-zag motion are determined according to the specific picking scenario. For example, the values may be determined according to the peduncle length or the damping ratio of the fruit. Such data may be collected and analysed in order to determine the most effective zig-zag motion for different scenarios.

FIGS. 7a and 7b show plan views of the bottom layer 14 of the ROI 16, segmented into blocks 18 as described above with reference to FIG. 3c, and illustrate the movement of the device 22 according to the horizontal multi-push operation described above.

In FIG. 7a, the position of the target fruit 4 in the xy plane is denoted by a dotted circle in block C_{C}. Blocks 18 containing obstacles 6 are labeled with vectors 20 with filled lines. As can be seen, FIGS. 7a and 7b depict a different arrangement to that shown in FIGS. 5a and 5b. In this arrangement, obstacles 6 are located in all of the blocks 18 apart from C_{F}. Consequently, the processor 32 determines that a horizontal multi-push operation appropriate.

FIG. 7b shows the path 21 of the device 22 following the horizontal multi-push movement. The positions of the device 22 in the xy plane at various points are denoted by dotted circles. As can be seen, the device 22 moves in a zig-zag motion from outside the ROI 16 (at the bottom of FIG. 7b) to the central block C_{C}, at which point it is located directly below the target fruit 4. This movement causes the device 22 to push aside obstacles 6 within the bottom layer 14 so that the obstacles 6 are no longer in a position to impede the subsequent picking process.

In a scenario where all of the blocks 18, excluding the central block C_{C}, are occupied, resulting in a value of D_{hori_multi}=0, the direction to move the device 22 is instead determined by calculating the shortest path from the current location of the device 22 to the centre of the bottom layer 14, i.e. the centre of the central block C_{C}. The movement of the device 22 in this direction is performed according to the zig-zag motion described above.

FIGS. 8a-d show a strawberry picking device 22 operating in accordance with the second stage of operation.

FIGS. 8a-d show the strawberry picking device 22 shown in FIGS. 5a and 5b, having completed the bottom layer 14 operations discussed above. Thus, in FIG. 8a, the device 22 is in the position shown in FIG. 5b. However, to improve clarity, only obstacles 6 within the lower-central layer 12 and the upper-central layer 10 are shown.

During the second stage of operation, the device 22 uses an upwards multi-push operation.

The upwards multi-push operation comprises the movement of the device 22 in a principally vertical direction towards the target fruit 4 and a side-to-side movement to clear obstacles 6.

In some embodiments, such as when the precise coordinates of the one or more obstacles 6 are known (for example, as shown in FIG. 4), the device 22 may be moved towards each obstacle 6 within the central layers 12, 10 in turn, from the lowest obstacle 6 to the highest obstacle 6, finishing at the centre of the central block C_{C} of the upper-central layer 10. In this case, the frequency and amplitude of the upwards multi-push operation are determined by the precise locations of the obstacles 6. A movement of the device 22 in accordance with this embodiment is shown in FIG. 11, which shows the path 41 of the device 22. With this movement, the device 22 moves between each of the obstacles 6 whilst simultaneously moving upwards to enclose the target fruit 4.

If only the general location of the one or more obstacles 6 is known, the processor 32 determines the largest group of adjacent occupied blocks 18 within the lower-central layer 12 and upper-central layer 10. The initial direction of the upwards multi-push operation in the xy plane is calculated based on the positions of the occupied blocks 18 according the following equation:

$${D}_{up\_multi} = - {\sum }_{i}^{n} {X}_{i} \qquad ( 3 )$$

In Equation 3, Xᵢ is the vector of the i^{th} occupied block 18 within the largest group of adjacent occupied blocks 18 and n is the total number of blocks 18 within the largest group of adjacent occupied blocks 18.

The device 22 moves in the initial direction D_{up_multi} whilst moving vertically in the z direction towards the target 4. FIG. 8b shows the position of the device 22 at this intermediate point. After a first predetermined time, the device 22 continues to move vertically, but in the opposite direction −D_{up_multi} in the xy plane. FIG. 8c shows the position of the device 22 at this later point. After a second predetermined time, the device 22 continues to move vertically but in the initial direction D_{up_multi} in the xy plane. This zig-zag motion is repeated until the target 4 is located within the locating members 24 of the device 22. This position of the device 22 is shown in FIG. 8d.

The first predetermined time and the second predetermined time (which determine the frequency and amplitude of the zig-zag motion) are determined according to the specific picking scenario. For example, the values may be determined according to the peduncle length or the damping ratio of the fruit. Such data may be collected and analysed in order to determine the most effective zig-zag motion for different scenarios.

FIGS. 9a-d show a strawberry picking device 22 operating in accordance with the third and fourth stage of operation.

FIGS. 9a-d show the strawberry picking device 22 shown in FIGS. 8a-d, having completed the lower-central layer 12 and upper-central layer 10 operations discussed above. Thus, in FIG. 9a, the device 22 is in the position shown in FIG. 8d. However, to improve clarity, only obstacles in the upper layer 8 are shown.

During the third stage of the method, the device 22 first determines whether there are obstacles in the central block C_{C} of the upper layer 8. If the central block C_{C} of the upper layer 8 is unoccupied, the device 22 may proceed directly to the fourth stage of the method and move upwards to pick the target strawberry 4. However, if the central block C_{C} of the upper layer 8 is occupied by an obstacle 6, as shown in FIG. 9a, the device 22 may risk swallowing the obstacle 6 were it to be moved upwards to capture the target strawberry 4. To avoid this, the device 22 uses a drag operation to move the target 4 further away from the obstacle 6.

The processor 32 determines the xy direction of the drag operation by identifying the region of the upper layer 8 that contains the maximum number of connected (adjacent) unoccupied blocks 18. Thus, the xy direction of the drag operation is given by the following equation:

$${D}_{drag} = - {\sum }_{j}^{m} {X}_{j} \qquad ( 4 )$$

In Equation 4, Xⱼ is the vector of the j^{th} unoccupied block 18 within the largest group of adjacent unoccupied blocks 18 and m is the total number of blocks 18 within the largest group of adjacent unoccupied blocks 18.

The device 22 moves from the position shown in FIG. 9a in the xy direction D_{drag} combined with an upwards movement to the position shown in FIG. 9b. As can be seen, this movement causes the target strawberry 4 to be moved into a region of the ROI 16 that is unoccupied. As shown in FIG. 9c, the device 22 may subsequently move upwards further and horizontally back to the central position of the ROI 16, thus pushing the obstacle 6 out of the central block C_{C} of the upper layer 8 of the ROI 16.

FIG. 9d shows the device 22 during the fourth stage of operation, in which the device 22 moves upwards to fully capture the target strawberry 4. In this position, the device 22 may begin the cutting operation to detach the target strawberry from its stem 5.

FIG. 10 shows a flowchart that illustrates the steps of an exemplary path-planning process in which only the general positions of the one or more obstacles 6 may be determined, in accordance an embodiment of the present invention. During the first step 100 of the method, a 3D image 2 of the target fruit 4 and its surroundings is obtained, an ROI 16 is determined and subsequently segmented into layers 8, 10, 12, 14 and blocks 18, as described above with reference to FIGS. 3a-c. The identified target fruit 4 is positioned at the centre of the ROI 16.

In step 110, if one or more obstacles 6 are identified in the bottom layer 14 of the ROI 16, the method proceeds with the first stage of the process, as described above with reference to FIGS. 5a and 5b.

During the first stage of the process, the largest group of adjacent unoccupied blocks 18 within the bottom layer 14 is determined (step 112). If the number of blocks 18 within this group is greater than or equal to the threshold (e.g. four) (step 113), the largest group of adjacent occupied blocks 18 within the bottom layer 14 is determined (step 114). The vectors 20 corresponding to the blocks 18 within this group are subsequently used to calculate the direction of a single-push operation and the starting position (step 116), as discussed above.

If the number of blocks 18 within the largest group of adjacent unoccupied blocks 18 within the bottom layer 14 is less than the threshold (e.g. four) (step 113), the vectors 20 corresponding to the blocks 18 within this group are subsequently used to calculate the direction, frequency and amplitude of a horizontal multi-push operation and the starting position (step 115), as discussed above.

If the calculation of the single-push operation or the horizontal-push operation results in a zero vector (steps 117, 119 respectively), or if no obstacles are located within the bottom layer (step 110), the path is instead determined by calculating the shortest path from the current location of the device 22 to the centre of the central block C_{C} of the ROI 16 (step 118).

In step 120, if one or more obstacles 6 are identified in the lower-central layer 12 or the upper-central layer 10 of the ROI 16, the operation proceeds with the second stage of the process, as described above with reference to FIGS. 8a-d.

During the second stage of the process, the largest group of adjacent occupied blocks 18 within the lower-central 12 and upper-central 10 layers is determined (step 122). The vectors 20 corresponding to the blocks 18 within this group are subsequently used to calculate the direction and first and second time periods for an upwards multi-push operation (step 124), as discussed above.

If no obstacles 6 are identified in the lower-central layer 12 or the upper-central layer 10 of the ROI 16 (step 120), the second stage of the process is omitted.

In step 130, if one or more obstacles 6 are identified in the central block C_{C} of the upper layer 8 of the ROI 16, the operation proceeds with the third stage of the process, as described above with reference to FIGS. 9a-c.

During the third stage of the process, the largest group of adjacent unoccupied blocks 18 within the upper layer 8 is determined (step 132). The vectors 20 corresponding to the blocks 18 within this group are subsequently used to calculate the direction of a drag operation (step 134), as discussed above.

If no obstacles 6 are identified in the upper layer 8 of the ROI 16 (step 130), the third stage of the process is omitted.

In step 140, an upwards movement of the device 22 is determined so that the target fruit 4 may be fully located within the locating members 24 and the cutting operation can be performed by separating the target fruit 4 from the stem 5. FIG. 9d shows the position of the device 22 having completed this movement.

In step 150, the path-planning algorithm is concluded and the device 22 may be moved along the determined path. Although, in this embodiment, the path is determined before the device 22 beings to move, in alternative embodiments, the path-planning process and the movement of the device 22 may be conducted simultaneously. This may be useful in a closed-loop vision guided manipulation system, in which the positions of the obstacles 6 and the position of the target 4 are updated continuously, thus allowing the parameters of the movement operations to be continuously recalculated to improve accuracy.

It can be seen from the above that, in at least preferred embodiments, the invention provides a method for determining a path for a robotic harvesting device, based on the position of obstacles, that, when traveled, serves to move said obstacles out of the way of the robotic harvesting device. By considering the positions of individual obstacles and determining a path according to how they may be repositioned to avoid accidental damage and/or harvesting, the accuracy and efficiency of the robotic harvesting process may be significantly improved.

Although the embodiments illustrated in FIGS. 1-11 have been shown in use with a strawberry picking device in particular, those skilled in the art will recognise that the method of the present invention may be used with a variety of different crops and/or a variety of different harvesting devices.

1. A method of controlling a robotic harvesting device to pick a target piece of fruit from a plant, the method comprising:
determining a position of the target piece of fruit to be harvested from the plant;
determining a position of one or more obstacles relative to the target piece of fruit; and
plotting a path for the robotic harvesting device to be moved along from a starting position to a picking position, wherein the path is plotted such that the movement of the robotic harvesting device along the path serves to move at least some of the one or more obstacles relative to the target piece of fruit such that the one or more obstacles do not impede the picking of the target piece of fruit by the robotic harvesting device.

2.-4. (canceled)

5. The method as claimed in claim 1, wherein:
said determining of a position of the target piece of fruit and/or a position of the one or more obstacles comprises capturing image data of the target piece of fruit and/or the one or more obstacles to generate an image or representation of the target piece of fruit and its surroundings;
the image or representation of the target piece of fruit is divided into a plurality of sub-volumes corresponding to a plurality of locations around the target piece of fruit, the plurality of sub-volumes comprising a plurality of columns and/or a plurality of rows; and
the plurality of rows defines one or more of: a sub-volume of the image or representation that is located above the target piece of fruit, a sub-volume of the image or representation that is located below the target piece of fruit and a sub-volume of the image or representation that is located around the target piece of fruit.

6. The method as claimed in claim 5, further comprising determining which of the plurality of sub-volumes contains an obstacle.

7. (canceled)

8. The method as claimed in claim 5, wherein each sub-volume of the plurality of sub-volumes is assigned one sub-vector of a plurality of sub-vectors.

9. The method as claimed in claim 8, wherein each sub-vector of the plurality of sub-vectors is directed from a center of the corresponding sub-volume to a center of the target piece of fruit.

10. The method as claimed in claim 1, wherein plotting the path for the robotic harvesting device to be moved along comprises determining a set of one or more path vectors.

11. The method as claimed in claim 10, wherein the one or more path vectors are determined using the determined position of the one or more obstacles.

12. The method as claimed in claim 11, wherein the directions of each path vector of the one or more path vectors is calculated from one or more of a plurality of subsets of sub-vectors that correspond to one or more of a plurality of subsets of sub-volumes.

13. The method as claimed in claim 12, wherein each subset of sub-volumes is determined using the determined positions of the one or more obstacles within the image or representation.

14. The method as claimed in claim 12, wherein each subset of sub-volumes comprises a plurality of adjacent sub-volumes all having the same characteristic representative of whether they are occupied or non-occupied by obstacles of the one or more obstacles.

15. The method as claimed in claim 14, wherein a subset of sub-volumes comprises a largest group of adjacent sub-volumes that all have the same characteristic representative of whether they are occupied or non-occupied by obstacles of the one or more obstacles.

16. The method as claimed in claim 1, wherein the path for the robotic harvesting device to be moved along comprises a plurality of sub-paths, optionally wherein each of the plurality of sub-paths is plotted substantially within a different region around the target piece of fruit.

17. The method as claimed in claim 16, wherein at least one sub-path of the plurality of sub-paths comprises a single linear movement or an oscillating movement of the robotic harvesting device within a region below the target piece of fruit.

18. The method as claimed in claim 16, wherein at least one sub-path of the plurality of sub-paths comprises a combined upwards and oscillating movement of the robotic harvesting device within a region proximal to the target piece of fruit.

19. The method as claimed in claim 16, wherein at least one sub-path of the plurality of sub-paths comprises a dragging movement of the robotic harvesting device that moves the target piece of fruit from a first position immediately below at least one of the one or more obstacles to a second, higher, position that is not immediately below at least one of the one or more obstacles.

20. (canceled)

21. The method as claimed in claim 1, further comprising identifying whether the one or more obstacles are movable or immovable.

22. The method as claimed in claim 1, further comprising moving the robotic harvesting device along the plotted path from the starting position to the picking position and controlling the robotic harvesting device to pick the target piece of fruit.

23. The method as claimed in claim 1, wherein the starting position is determined by determining the largest opening angle between two obstacles, having no obstacles therebetween, and positioning the starting position at the midpoint of the opening angle.

24. A non-transitory computer readable storage medium storing computer software code which when executing on a data processing system performs a method as claimed in claim 1.

25. An apparatus for picking a target piece of fruit from a plant, the apparatus comprising:
a picking device for detaching the target piece of fruit from the plant;
a maneuvering mechanism for moving the picking device along a path towards the target piece of fruit;
one or more sensors for capturing data representative of positions of the target piece of fruit and one or more obstacles; and
processing circuitry operable to:
determine a position of the target piece of fruit to be harvested from the plant using the data captured by the one or more sensors;
determine a position of the one or more obstacles relative to the target piece of fruit using the data captured by the one or more sensors; and
plot the path for the picking device to be moved along from a starting position to a picking position by the maneuvering mechanism, wherein the path is plotted such that the movement of the picking device along the path serves to move at least some of the one or more obstacles relative to the target piece of fruit such that the one or more obstacles do not impede the picking of the target piece of fruit by the picking device.
